(19) United States
(12) Patent Application Publication
(10) Pub. No.: US 2008/0121507 A1
(43) Pub. Date: May 29, 2008

(54) Key structure

(75) Inventor: Tsung-Min Chen, Taipei Hsien (TW)

Correspondence Address: BIRCH STEWART KOLASCH & BIRCH, PO BOX 747, FALLS CHURCH, VA, 22040-0747, US

(73) Assignee: Chicony Electronics Co., Ltd.

(21) Appl. No.: 11/730,520

(22) Filed: Apr. 2, 2007

(30) Foreign Application Priority Data
Nov. 24, 2006 (TW) 95220744

(51) Int. Cl. H01H 13/70; H01H 13/10

(52) U.S. Cl. 200/344; 200/293; 200/341

(57) ABSTRACT

A key structure comprises a base, a key support structure consisting of a first frame and a second frame, and a key cap, characterized in which a paired pivots are disposed on the first frame, and a paired duplex bearing members are configured beneath the key cap for jointing the paired pivots of the first frame.

### BACKGROUND OF THE INVENTION

1. Field of the Invention

The present invention relates to a key structure, and more particularly to a structurally sturdy and enhanced key structure.

2. Description of the Related Art

Along with the development of the information industry, computers have become prevalent in our daily life for work or personal use. Computer peripherals such as mouse and keyboard are also indispensable instruments for computer use.

Keyboard plays an important role in the use of computer. FIG. 2 shows an exploded view of a conventional key structure on a keyboard, which comprises a key cap 100, a first frame 200, a second frame 280, a base 310 and another base 320.

The key cap 100 consists of two bearing members 120 and two stop members 130, and the bearing member 120 is configured with a concavity 121. The first frame 200 comprises a paired pivots 210, two clasping members 220, and a paired center shafts 260. The second frame 280 comprises two fastening members 250, two clasping members 220, and two shaft holes 270. It should be noted that the center shaft 260 of the first frame 200 corresponds to the shaft hole 270 of the second frame. Both base 310 and base 320 have a plurality of fixation holes 330.

For the assembly of the conventional key structure, the center shaft 260 of the first frame 200 is jointed in the shaft hole 270 of the second frame 280, so that a key support structure is formed from the first frame 200 and the second frame 280. Furthermore, the pivot 210 on the first frame 200 of the key support structure is seated into the concavity 121 on the bearing member 120 of key cap 100, and the clasping members 220 on the second frame 280 of the key support structure are coupled with the stop members 130 of the key cap 100. And the two clasping members 220 of the first frame 200 and the two fastening members 250 of the second frame 280 are jointed to the base 310 and the base 320 to form a key.

However, such assembly of keys cannot withstand harsh usage, because it uses only the bearing member 12 of the key cap 100 to connect to the pivot 210 of the first frame 200 for stabilization, which fails to have sufficient sturdy key assembly. The basic requirements for a keyboard is that the key caps 100 should not be easily damaged or dislodged by user under regular use, and the keys should remain sturdy after being used for a long period of time. But under the assembly as described above, a force of approximately 1 kg to 3 kg can pull up the key cap 100 easily, and the keys will become unstable and start to wiggle after being used for a period of time. Therefore, the keyboard starts to break down over time.

As such, it is necessary to develop a kind of key structure that can withstand harsh usage environment, such as in industrial and military applications, and help improve product reliability and durability over time.

### SUMMARY OF THE INVENTION

To address the limitation of keyboard usage as described above and further improve the product reliability, the object of the present invention is to provide a key support structure with sturdier and more reliable in usage. To achieve this object, a key structure of to the present invention comprises a base, a key support structure consisting of a first frame and a second frame, and a key cap, characterized in which a paired pivots are disposed on the first frame, and a paired duplex bearing members are provided beneath the key cap for jointing the paired pivots of the first frame.

Preferably, the pivot is provided with a partitioning board.

Preferably, the partitioning board is secured to the duplex bearing member.

Preferably, the duplex bearing member consists of two bearing members.

The use of duplex bearing member and partitioning board on the bearing of the present invention provides a key structure that is more suitable for harsh usage environment, such as in industrial and military applications, where its key cap is not easily pulled out by the user. Such key structure improves product reliability over time and keeps the key in good condition without wiggling.

### BRIEF DESCRIPTION OF THE DRAWINGS

FIG. 1A is an exploded view of the key structure according to the invention.

FIG. 1B is a side view of the assembled key structure according to the invention.

FIG. 2 is an exploded view of the conventional key structure.

### DETAILED DESCRIPTION OF THE INVENTION

The present invention will be fully described with preferred embodiments and accompanying drawings. It should be understood beforehand that any person familiar with the skill is able to make modification to the invention described and attain the same effect, and that the description below is a general representation to people familiar with the skill and should not be construed as a limitation on the actual applicable scope of the present invention.

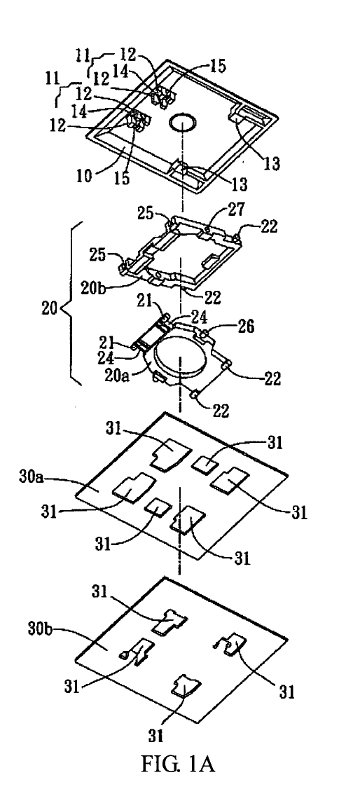

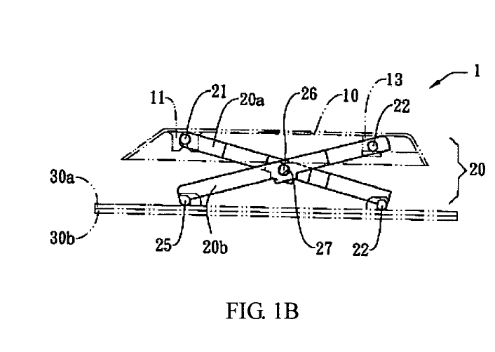

Referring to FIG. 1A and FIG. 1B which shows respectively an exploded view and a side view of the key structure 1 according to the present invention. The key structure 1 comprises a base, a key support structure 20, and a key cap 10. Wherein the base is composed of a baseboard 30a and a baseboard 30b, and the key support structure 20 is composed of a first frame 20a and a second frame 20b.

Again referring to FIG. 1A, the baseboard 30a and the baseboard 30b are provided with a plurality of fixation holes 31. A paired pivots 21 are disposed on one side of the first frame 20a, and two clasping members 22 are provided on the other side of the first frame 20a opposing the pivots 21. A partitioning board 24 is disposed at a proper location on the pivots 21. Each of the other two sides of the first frame 20a corresponding to the pivots 21 and clasping members 22 includes a center shaft 26.

Two fastening members 25 are provided on one side of the second frame 20b, and two clasping members 22 are disposed on the other side of the second frame 20b opposing the fastening members 25. Each of the other two sides of the first frame 20b corresponding to the fastening members 25 and the clasping members 22 includes a shaft hole 27.

Another surface of the key cap 10 opposing the user contact surface is disposed with a paired duplex bearing members 11 and two stop members 13. Each duplex bearing member 11 includes two bearing members 12, wherein each of the two bearing members has a hole member 15. It should be noted that an accommodation member 14 is configured between the two bearing members 12 of the duplex bearing member 11, which allows the seating of partitioning board 24 of the first frame 20a during assembly for securing the duplex bearing member 11. In addition, the bearing members 12 of the duplex bearing member 11 on the key cap 10 are corresponding to the pivots 21 of first frame 20a, while the stop members 13 are corresponding to the clasping members 22 of second frame 20b.

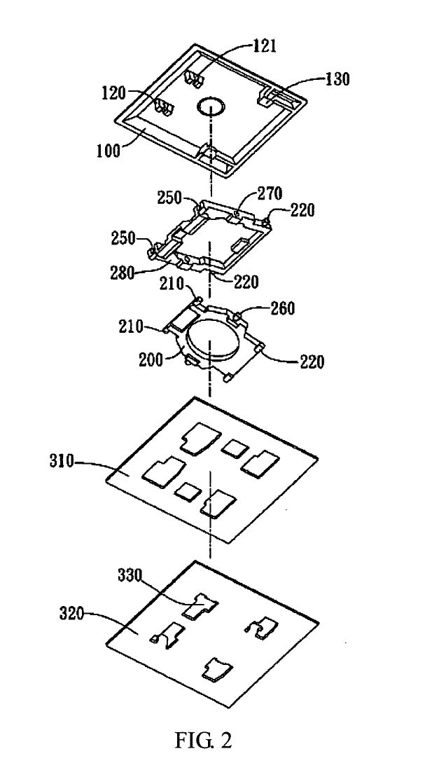

In the assembly process, the first frame 20a and the second frame 20b form a key support structure 20 after the jointing of the shaft hole 27 and the center shaft 2. Next, the pivots 21 on the first frame 20a of the key support structure 20 are jointed to the duplex bearing members 11 of the key cap 10, and the pivots 21 are sleeved into the hole members 15. During the pivot jointing, the partitioning boards 24 on the pivots 21 of first frame 21a are seated into the accommodation members 14 on the bearing members 12 of duplex bearing members 11, and the clasping members 22 on the second frame 20b are clasped to the stop members 13 of key cap 13. Then the clasping members 22 on the first frame 20a and the fastening members 25 on the second frame 20b are fitted into the fixation holes 31 of baseboard 30a and the baseboard 30b to form an assembled key. The side view of the assembled key is shown in FIG. 2.

As such, product reliability is improved and the key structure is made more stable and sturdy that it will not deteriorate by starting to wiggle after being used for a period of time.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A key structure, comprising a base, a key support structure composed of a first frame and a second frame, and a key cap, characterized in which:
a paired pivots are disposed on said first frame, and a paired duplex bearing members are configured beneath said key cap for jointing the paired pivots of said first frame.

2. The key structure according to claim 1, wherein said pivot is provided with a partitioning board.

3. The key structure according to claim 2, wherein said partitioning board is used for securing said duplex bearing member.

4. The key structure according to claim 1, wherein said duplex bearing member consists of two bearing members.
